(19) United States
(12) Patent Application Publication
(10) Pub. No.: US 2021/0182036 A1
(43) Pub. Date: Jun. 17, 2021

(54) HARDWARE PLATFORM SPECIFIC OPERATOR FUSION IN MACHINE LEARNING

(71) Applicants: Farhan SHAFIQ, Markham (CA); Ye TIAN, Markham (CA); Mostafa ELHOUSHI, Richmond Hill (CA); Boris KRAVCHENKO, Mississauga (CA)

(72) Inventors: Farhan SHAFIQ, Markham (CA); Ye TIAN, Markham (CA); Mostafa ELHOUSHI, Richmond Hill (CA); Boris KRAVCHENKO, Mississauga (CA)

(73) Assignee: HUAWEI TECHNOLOGIES CO., LTD., SHENZHEN (CN)

(21) Appl. No.: 16/712,449

(22) Filed: Dec. 12, 2019

(51) Int. Cl. G06F 8/41; G06N 3/04

(52) U.S. Cl. CPC G06F 8/427; G06N 3/04

(57) ABSTRACT

A method and associated apparatus for generating a neural network computation graph. The method includes receiving, by a compiler, a computation graph representing a neural network. The computation graph includes a plurality of nodes, each node associated with an operator of the neural network. The compiler receives a list of fusion patterns associated with a target hardware execution device, and analyzes the computation graph using the list of fusion patterns. The compiler generates one or more fused operators based on the analysis, each fused operator including at least two operators of the plurality of operators which can be fused. The compiler generates a new computation graph representing the neural network that includes at least a first fused operator of the generated one or more fused operators.

### FIELD OF THE INVENTION

The present invention pertains to the field of compiling computer code for artificial neural network models which are used in the field of machine learning.

### BACKGROUND

Modern machine learning solutions such as deep neural networks use the operators (ops) system to maximize software compatibility and composability. Machine learning application developers use ops to create new algorithms by assembling ops as the building blocks to form a neural network. For instance, a typical convolution neural network (CNN) layer may consist of numerous basic operations that are acceleration targets. A computation graph is used to demonstrate how data flows among different ops in a neural network. At runtime, an execution engine dispatches ops to different execution units such as central processing units (CPUs), graphics processing units (GPUs) or special-purpose accelerators. In this approach, the accelerators have to operate in a passive mode, i.e., they stay idle until a new op is formed and dispatched to them by the execution engine which usually runs on a host CPU.

In the case of accelerators (e.g., GPU, network processing unit (NPU), application specific integrated circuit (ASIC) or field programmable gate array (FPGA)), the dispatch overhead (sometimes also called offloading) of a single op can be quite significant especially when the computation inside an op is small. As a result, there is observed significant overhead of running small batch size models using ops system for accelerators. Operator fusion is used to address this overhead, where multiple operations are combined together into one operation and dispatched once, which results in significant reduction of overhead. Operator fusion combines multiple operators into a single kernel without saving the intermediate results in memory. This optimization can greatly reduce execution time, particularly in GPUs and specialized accelerators. Apart from reducing op dispatch overhead, op-fusion also helps reduce the performance overheads caused due to back and forth movement of data between the host and accelerator. In a given machine learning (ML) framework, op-fusion passes corresponding to the target accelerator are implemented in the framework's compilation flow. A fusion pass identifies a specific pattern of operations in the computation graph and replaces it with a fused operation.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide techniques that overcome at least some of the limitations of the prior art. An object of the present invention is to enable hardware platform specific operator fusions in a machine learning neural network. The operator fusions may be performed on a computation graph (e.g. representing a Neural Network) during an optimization process. The optimization process may occur as part of compiling of computer code in the machine learning framework.

Accordingly, an aspect of the present invention provides a method of generating a neural network computation graph. The method includes receiving, by a compiler, a computation graph representing a neural network. The computation graph includes a plurality of nodes. Each node is associated with an operator of the neural network. The method includes receiving, by the compiler, a list of fusion patterns associated with a target hardware execution device. The method includes analyzing, by the compiler, the computation graph. The analyzing by the compiler is performed using the list of fusion patterns. The method includes generating one or more fused operators based on the analysis. Each fused operator includes at least two operators of the plurality of operators which can be fused. The method includes generating, by the compiler, a new computation graph representing the neural network that includes at least a first fused operator of the generated one or more fused operators.

In one aspect, the method includes determining, based on a cost model associated with the target hardware execution device, a computation cost associated with the generating of each of the one or more fused operators. Furthermore, the analyzing is based on the computation cost associated with the generating of each of the one or more fused operators.

In another aspect, each fusion pattern in the list of fusion patterns is associated with a condition for generating a fused operator. In some embodiments or aspects, the condition relates to at least one of: a memory allocation requirement associated with the fused operator; a size of a feature map input to a layer of the neural network; and a size of a filter of a layer of the neural network.

In yet another aspect, the neural network includes a convolution layer and the above-mentioned condition specifies a constraint on at least one of: a shape of a kernel of the convolution layer; a size of the kernel of convolution layer; and a data type of an execution kernel associated with the fused operator.

In one embodiment or aspect, each of the generated one or more fused operators specify a dataflow of computations which are equivalent to the dataflow of computations of the plurality of nodes of the computation graph representing the neural network.

In one variation, the method further comprises outputting the generated one or more fused operators to the target hardware execution device for execution.

In yet another embodiment or aspect, the method further comprises assigning priorities to each fusion pattern in the list of fusion patterns based on a cost model.

In one embodiment or aspect, the generated one or more fused operators are output to the target hardware execution device for execution in accordance with the priorities assigned to each fusion pattern in the list of fusion patterns.

Also provided, in another broad embodiment or aspect, is a non-transitory computer readable medium storing instructions executable in one or more processors. The instructions when executed in the one or more processors cause various operations to be performed. The operations include receiving, by a compiler, a computation graph representing a neural network, the computation graph comprising a plurality of operators of the neural network. The operations include receiving, by the compiler, a list of fusion patterns associated with a target hardware execution device. The operations include analyzing, by the compiler, the computation graph using the list of fusion patterns and generating one or more fused operators based on the analysis, each fused operator comprising at least two operators of the plurality of operators which can be fused. The operations include generating, by the compiler, a new computation graph representing the neural network that includes at least a first fused operator of the generated one or more fused operators.

In yet another broad aspect, an apparatus (machine) is provided which includes a processor; and a memory storing instructions that when executed by the processor cause the apparatus to: receive a computation graph representing a neural network, the computation graph comprising a plurality of nodes, each node associated with an operator of the neural network; receive a list of fusion patterns associated with a target hardware execution device; analyze the computation graph using the list of fusion patterns; generate one or more fused operators based on the analysis, each fused operator comprising at least two operators of the plurality of operators which can be fused; and generate a new computation graph representing the neural network that includes at least a first fused operator of the generated one or more fused operators.

### BRIEF DESCRIPTION OF THE FIGURES

Further features and advantages of the present invention will become apparent from the following detailed description, taken in combination with the appended drawings, in which:

FIG. 1 shows a conventional framework for handling fusion operations;

FIG. 2 provides an illustrative overview of a proposed system for platform specific fusions operations;

FIG. 3 illustrates, in an example embodiment, a proposed approach that provides adaptable operator fusion patterns;

FIGS. 4A and 4B illustrate examples of non-prioritized and prioritized operator fusion patterns respectively;

FIG. 5 illustrates an example of performance estimation for fused operations; and

FIG. 6 illustrates, in one example embodiment, a method of generating a neural network computation graph including fused operators.

It will be noted that throughout the appended drawings, like features are identified by like reference numerals.

### DETAILED DESCRIPTION

As opposed to current machine learning frameworks, where fusion passes as well as the fusion pattern are part of the compiler, the present invention described herein provides an approach that decouples the fusion patterns from the fusion passes and the compiler. This enables the compiler to be independent of any updates or changes to the target platform's supported operator fusions. The compiler source code does not need to be rebuilt with every change in the target platform. As used herein, the terms “target platform,” “hardware platform” and “hardware execution device” are used interchangeably. A platform can refer to an item of electronic hardware which can execute compiled code. The platform can additionally include associated software, firmware, or a combination thereof. Examples of platforms or execution devices include purpose-built computation devices including purpose-built or generic computer processing components.

A compiler refers to a computing device which translates computer code written in a first programming language into computer code written in a second language. Typically, the first language is a relatively high-level human readable programming language, while the second language is a machine-readable language such as an assembly language, object code or machine code. The output of the compiler can be a program that is readable and executable by a certain machine, the target platform.

In embodiments or aspects of the present invention, the operator fusions file is read into a pattern matching facility. The operator fusions file is also referred to herein as a pattern file. It is noted that the operator fusions file can be updated by the user independent of the compiler. The operator fusions file can refer to or include a list of fusion patterns associated with a target platform. These fusion patterns represent structured combinations of component operators that may appear in a provided computation graph, and pattern matching is performed based on the fusion patterns. A pattern matcher is provided which identifies sub-graphs (of the provided computation graph) that can be fused together based on particulars of the target platform. The pattern matcher also creates a new fused operator for each pattern. The parameters of each individual operator in the pattern are analyzed (as well as conditions if they exist). Then, the new fused operator's parameter lists are populated if the fused operator would require these parameters as part of its computation. The parameters may include data types, tensor shapes, data formats, and any other hyper-parameters that are specific for the individual ops within the sub-graph. Next, the matched pattern in the original graph is replaced with the new fused operator. This process is repeated for some or all patterns in the operator fusions file, eventually resulting in a new computation graph containing all supported fused operators.

In this description, the embodiments or aspects are not necessarily limited to any specific frameworks, and are also applicable to other open source state of the art frameworks. A framework can refer to an interface, library or tool which allows for an application, such as a machine learning application, to be built from readily available and convenient components. The framework can specify computation graphs according to a particular format, and the compiler can be configured to process graphs specified in this format. The application may be a software application using a neural network model. The neural network model may be a model which is adapted via machine learning during a training phase and then deployed during an inference phase. The computation graph may be used as a representation of the neural network, in which ops are computation blocks and the connections between ops represents how data flows therebetween. A computation graph may represent a neural network in the sense that it specifies, in a symbolic and structured way, a set of ops and interconnections between ops. In this sense the graph employs the same set of ops and interconnections which are implemented by the neural network.

It should be understood that fusions may be performed according to an optimization pass performed by the compiler. This pass is performed in order to process a neural network model as described in the machine learning framework, and as specified using a computation graph.

Furthermore, the invention can be applied to different variations of accelerators that enable platform specific op-fusion such as ASICs, FPGAs, etc., allowing a machine learning framework to be easily extensible to newly created hardware without having to re-compile its code. Embodiment solutions provided herein thus enable ML frameworks to seamlessly support hardware platform specific fusions without prior knowledge of the platforms, and without requiring re-writing of the compiler's code.

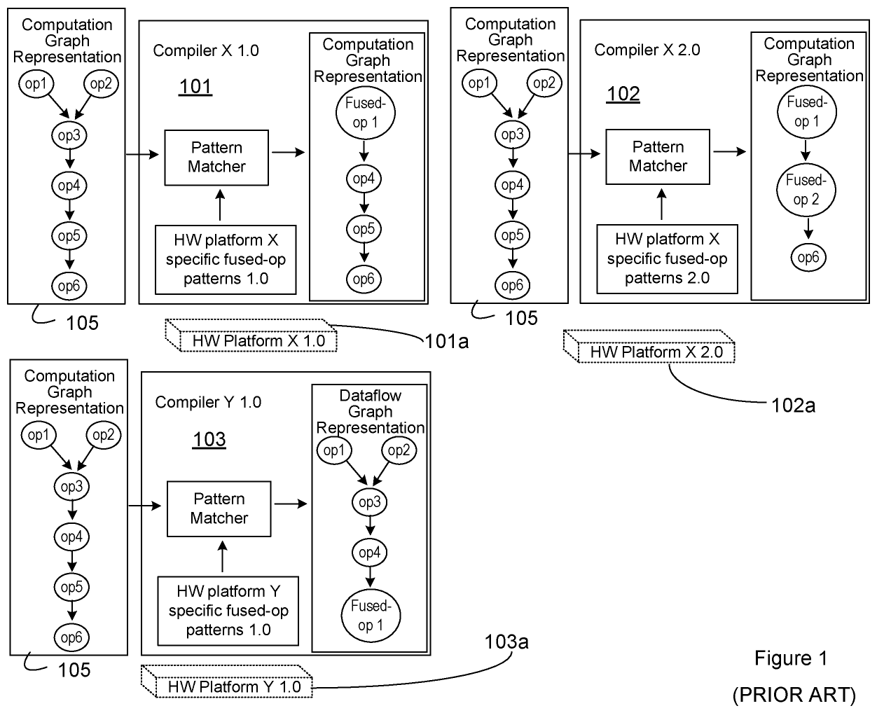

FIG. 1 illustrates a conventional framework for handling target platform-specific fused operators. These are fused operators associated with particular target platforms (i.e. target hardware execution devices). Three different hardware platforms 101a, 101b, 101c are shown. Each hardware platform is associated with a different compiler, labelled 101, 102, 103, respectively. The compiler would need to be updated every time new fused operation capabilities are added for an associated hardware platform. As illustrated, a computation graph 105 is provided to each compiler. Each compiler 101, 102, 103 includes a pattern matcher which detects patterns within the computation graph 105, where those patterns correspond to fused operators supported by the particular hardware platform 101a, 101b, 101c associated with that compiler. The pattern matcher then replaces the detected patterns with the corresponding fused operators. For example, hardware platform 102a supports the following fused operators: Fused op 1 which performs op1 and op2, feeds the results into op3 and then performs op3; and Fused op 2 which performs op4, feeds the results into op5, and then performs op5. Therefore, the pattern matcher for compiler 102 detects the presence (and required arrangement), in the computation graph 105, of op1, op2 and op3 and replaces this with Fused op 1, and also detects the presence (and required arrangement) of op4 and op5 and replaces this with Fused op 2. Each compiler is specific to an associated hardware platform. A fused operator generally performs the same functions as at least two component operators. When component operators are present in a particular arrangement that matches one of the patterns in the provided list of fusion patterns, it is said that these component operators can be fused. The corresponding fused operator is then generated. Generation of a new computation graph is also performed. This involves modifying the input computation graph to replace the component operators which can be fused with the corresponding generated fused operator.

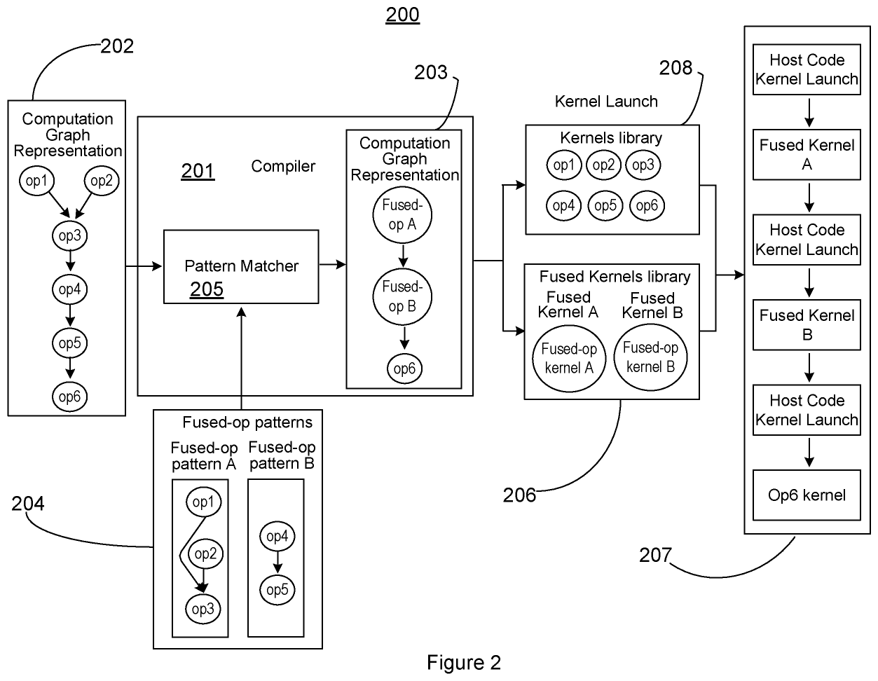

FIG. 2 is an overview, in one embodiment or aspect of the present invention, of a system 200 for platform specific fusion operations and demonstrates an overall architecture of the system. Users (e.g., application developers) provide (1) a computation graph 202 of a dataflow application and (2) a pattern file 204 containing graph representations of supported fused operator patterns for a target hardware platform. The computation graph 202 and the pattern file 204 are provided to a compiler 201 which includes several components which are described below. The computation graph 202 indicates a set of operations to be performed, along with the interdependencies of the operations, e.g. which operations are to provide output to which other operations. The operations are performed by respective operators. The computation graph generally represents a neural network, that is, a plurality of computation operations to be performed by the neural network. The computation graph 202 includes various nodes, labeled op1, op2, op3, op4, op5, op6. Each of these nodes is associated with an operator of the neural network.

Computation graphs as presented herein generally represent neural networks. Neural networks are routinely represented using computation graphs. A computation graph is a directed graph in which nodes correspond to operators (operations) or variables. Nodes can feed into one another, such that output of a node is provided as input to another node. These input/output relationships are represented as directed connections (edges) in the graph. Therefore, complex series of operations of the neural network can be represented in graphical form as a particular arrangement of interdependent component operations. Neural networks themselves can refer to computational systems which can be applied as part of machine learning or artificial intelligence. Neural networks may be generally modelled on the structure of a biological brain, with its attendant interconnected system of neurons. The neural network includes a system of interconnected nodes, each of which performs a function.

Neural network operators can refer to computational functions which process one or more given inputs in a particular way to produce one or more outputs. The behaviours of operators can be represented using mathematical functions, or other types or rule sets specifying input/output behaviours. Similarly to how multiple mathematical or computational functions can be combined together, multiple operators can be combined together to form fused operators. A fused operator operates the same as a corresponding structured collection of component operators, including accepting all inputs of the collection of component operators and producing all outputs of the collection. Input/output behaviour of the fused operator is substantially the same or at least comparable to that of the structured collection of component operators.

A simple illustrative mathematical example of an operator fusion is as follows. A first operator receives two inputs (in context of a CNN, a and b are typically tensors) a and b and produces an output corresponding to a first mathematical function f(a,b). For example, the function can be f(a,b)=conv(a,b). A second operator receives two inputs c and d (where either c or d is output of the first function) and produces an output corresponding to a second mathematical function g(c,d). For example, the function can be g(c,d)=Batchnorm(c,d). Then, the first and second operators can be fused into a fused operator which receives a, b and d, applies the first operator to a and b, and applies the second operator to the output of the first operator and the input d. Thus, the output of the fused operator is g(f(a,b),d), which, in the given example equals Batchnorm(Conv(a,b),d).

Embodiments or aspects of the invention, as described herein, relate to a system that enables machine learning frameworks to support platform specific fused operator for any given accelerator without prior knowledge of said platform. As can be seen, because the compiler 201 accepts general pattern files 204, it can be used for different hardware specific platforms, and can be readily updated if the capabilities of a given hardware specific platform change.

The pattern file 204 indicates a list of fusion patterns associated with a target hardware execution device, also referred to as a target hardware platform. The fusion patterns may represent sets of operators that can be performed together in a particular way by the hardware execution device as a unitary operation. The set of operators is represented along with the interdependencies between those operators. Multiple operations that are performed together as a unitary operation are also referred to as fused operators. An operation can be unitary from the perspective that a target hardware platform can implement the fused operator based on a single instruction, rather than a series of instructions. The target platform may implement the fused operator in a single step or in multiple steps, depending on the operation and the platform architecture and capabilities.

In more detail, the pattern file 204 is provided as an input to the compiler 201. The pattern file contains sub-graph representations of supported fusion patterns (also referred to as fused operator patterns) for a target hardware platform. Each supported pattern is assigned a corresponding fused operator name, which also corresponds to the underlying execution kernel. Each fusion pattern may also have an optional condition description (e.g., constraints on kernel sizes, shapes, data types etc.).

In more detail, the execution kernel may be low-level (machine readable) code that is executable on the target hardware. For each op supported by the target hardware, a corresponding execution kernel is provided. Typically the code in the execution kernel is configured based closely on the native capabilities and features of the target hardware, and implements operations in a way that is optimized specifically for that target hardware. A compiler takes a high-level neural network and maps the ops specified therein (in the computation graph) to their corresponding execution kernels. When a single compiler supports multiple hardware back-ends (target platforms), the compiler is configured to map the ops specified in the computation graph to the correct kernels.

Pattern files are typically provided by the target platform provider. Because of this, a mechanism is in place to identify the kernels to be mapped to a fused operator for that target platform. This mapping may be achieved, for example, by using the same name or adding a kernel-id or kernel name for each pattern into the pattern file.

Fusion may be performed based on a priority assigned to each pattern. Priority assignment specifies the relative order in which patterns are prioritized. That is, a priority assignment specifies which operator patterns are replaced with corresponding fused ops before which other operator patterns, particularly when two or more potentially overlapping patterns appear in a computation graph. By default, priority is assigned based on the number of nodes, i.e. the pattern with the most nodes has the highest priority. Other bases for priority assignment can also be specified and applied. That is, if two fusion patterns are present in a computation graph, the prioritization directs the pattern matcher 205 to replace a higher-priority pattern with its corresponding fused operator, rather than a lower-priority pattern. In one embodiment or aspect, this may be performed by searching the computation graph for patterns one at a time, such that higher-priority patterns are searched for before lower-priority patterns.

The compiler 201 includes a pattern matcher 205. The compiler in general, and the pattern matcher 205 in particular, analyzes the computation graph 202 using the pattern file 204. In more detail, the pattern matcher 205 reads the provided pattern file 204 containing sub-graph representations of supported operator fusion patterns. The pattern matcher 205 then parses through the computation graph 202 of the dataflow application, identifying pattern matches. A pattern match occurs when a portion of the computation graph 202 matches with one of the patterns in the pattern file 204. This portion is referred to as the matched portion. When a pattern match is identified, the compiler replaces the matched portion with a single node, which is assigned a label. The label is given in the pattern file and is associated with the pattern in the pattern file that corresponds to the matched portion. This single node is referred to as a fused operator, and represents a fused operator supported by the target hardware platform.

After identifying some and possibly all pattern matches in the computation graph, the pattern matcher outputs a new computation graph 203 that corresponds to the input computation graph 202, but in which at least some and typically all instances of those patterns in the pattern file 204 which occur in the input computation graph 202 are replaced with their corresponding fused operators. That is, the computation graph 203 functions similarly to the computation graph 202, but groups of operations in the computation graph 202 are replaced with fused operators which perform equivalent functions, according to the pattern file 204. According to this process, one or more fused operators are generated. As can be understood from the above, each fused operator includes at least two operators, of the input computation graph, which can be fused together, in the sense that the target hardware platform can implement the two operators together in a particular way that reflects the operator interdependencies given in the computation graph 202.

For example, in FIG. 2, the pattern file 204 specifies two fused operators, namely Fused op pattern A and Fused op pattern B. Fused op pattern A includes operators op1 and op2 being performed, the results being passed to operator op3, and op3 being performed. Fused op pattern B includes operator op4 being performed, the results being passed to operator op5, and op5 being performed. The pattern matcher 205 receives the computation graph 202, reads the pattern file 204 and parses the computation graph 202 for instances of all patterns occurring in the pattern file 204. The topmost portion of the computation graph 202 corresponds to an instance of Fused op pattern A, while a portion of the computation graph immediately below the topmost portion corresponds to an instance of Fused op pattern B. Therefore, the pattern matcher 205 identifies one instance of Fused op pattern A and one instance of Fused op pattern B. The compiler then replaces, in the computation graph 202, the group of operators op1, op2, op3 with Fused op A, and replaces the group of operators op4, op5 with Fused op B, thereby generating the new computation graph 203.

Also illustrated in FIG. 2 is a fused kernel library 206. The fused kernel library 206 (also referred to as a fused operator kernel library) contains the supported underlying fused kernels corresponding to each fused operator for the target hardware platform. Also illustrated in FIG. 2 is a kernel library 208, which contains the kernels corresponding to each individual operator that may potentially occur in the new computation graph 203 even after pattern matching and replacement. This may occur for example when individual operators occur in the computation graph but not as part of a pattern contained in the pattern file 204.

As illustrated in FIG. 2, a new host source code module 207 is also generated. The module 207 is generated such that it indicates and accessibly stores the ops which have been combined together to form fused operators. During run time, the fused operator is selected by the framework engine to be offloaded to hardware accelerators instead of the individual ops. The source code module 207 reflects the new computation graph 203, but in terms of launching and implementing, in order, those kernels which correspond to nodes in the new computation graph 203. In particular, the new computation graph 203 specifies, in order, that operations Fused op A, Fused op B and op6 are to occur in order. The source code module 207 therefore specifies that Fused Kernel A is launched, followed by Fused Kernel B, followed by the op6 kernel. These kernels can be obtained from the libraries 206, 208.

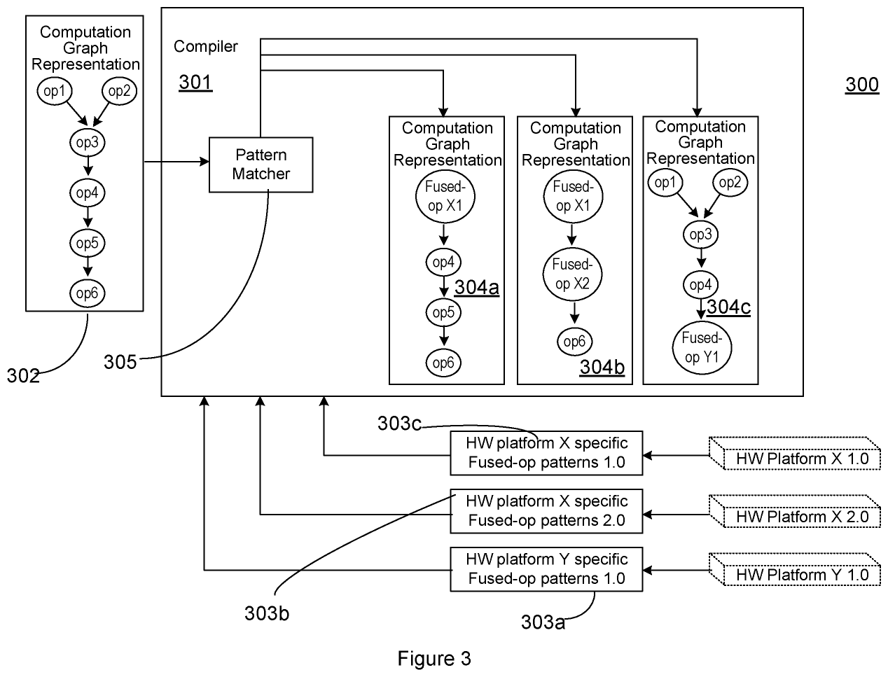

FIG. 3 illustrates, in an example embodiment or aspect, a system 300 that provides adaptable operator fusion patterns and enables a single compiler 301 to perform op-fusions for various hardware (HW) platforms 306a, 306b, 306c based on provided computation graph 302 and pattern files 303a, 303b, 303c corresponding to the HW platforms 306a, 306b, 306c, respectively. Each pattern file contains a list of fusion patterns associated with its corresponding HW platform. The compiler 301 includes a pattern matcher 305. Input computation graph 302 is used to generate, in compiler 301, fused op computation graph 304a, 304b and 304c corresponding to lists of fusion patterns 303a, 303b, 303c of various hardware (HW) platforms. The system 300 operates similarly to the system 200, except that multiple different HW platforms are explicitly supported, either concurrently or sequentially. The pattern matcher 305 receives the computation graph and each pattern file. Separately, for each pattern file, the pattern matcher 305 analyzes the computation graph to identify instances of the fusion patterns that occur in that pattern file. For example, the computation graph 304a is provided as output from the pattern matcher 305 in response to analyzing the input computation graph 302 using the list of fusion patterns present in the list of fusion patterns 303a. A new computation graph 304a including fused operators is generated based on the analysis, for example by replacing, in the input computation graph 302, instances of patterns appearing in the list 303a with their corresponding fused operators.

Analyzing a computation graph using a list of fusion patterns can thus refer to the process, by the compiler, of processing the computation graph to detect instances of fusion patterns in the provided list of fusion patterns. The analysis can also include pattern prioritization, as discussed below. In the pattern prioritization, when multiple overlapping instances of fusion patterns occur in the computation graph, one or more of the detected fusion patterns are flagged for replacement with a corresponding fused operator, while the remaining detected fusion patterns are not replaced with fused operators. This is because once the prioritized fusion patterns are replaced with their corresponding fused operators to create a modified computation graph, the other detected fusion patterns cease to exist in the modified computation graph.

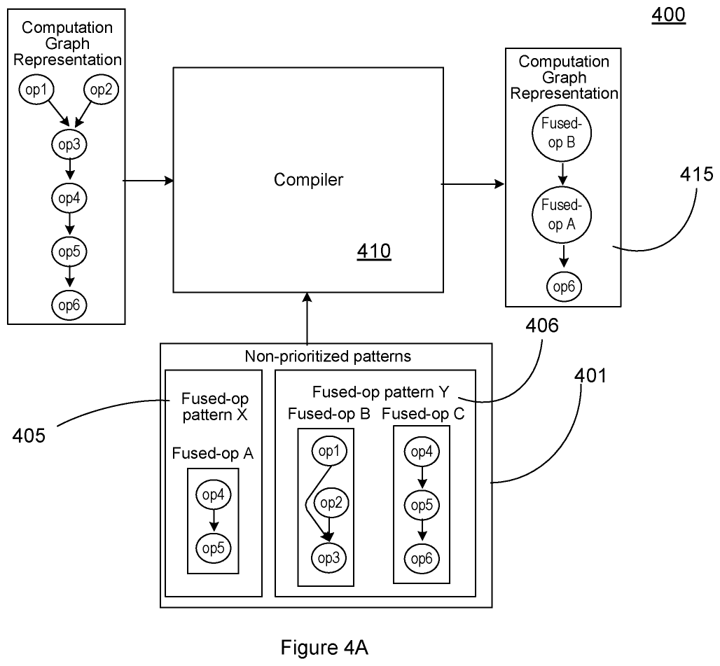

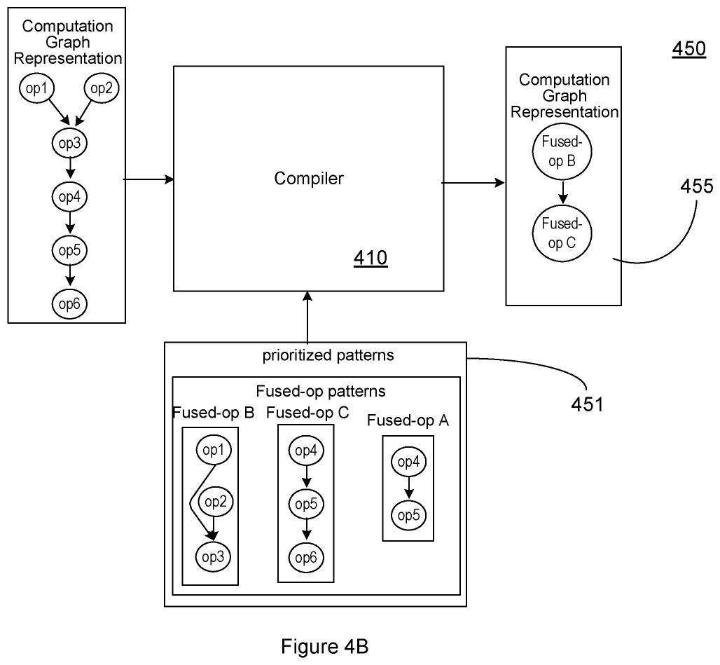

In order to make operator fusion patterns adaptable such that a previous fusion pattern does not hinder fusibility of any new overlapping patterns, a prioritized list of patterns may be used, such that all patterns are sorted based on some criterion. An example criterion for sorting could be “a maximum number of fused operators in a pattern”. Other sorting criteria could be: maximum memory optimization; maximum compute utilization; minimum number of operators in the new computation graph; etc. FIGS. 4A, 4B as described below highlight the difference between operator fusions relying on non-prioritized patterns as opposed to prioritized patterns.

The pattern matcher 305 identifies sub-graphs that can be fused together based on the target platform and creates a new fused operator for each pattern. The parameters of each individual operator in the pattern (as well as conditions such as specified) are analyzed, and then applied to populate the new fused operator's parameter lists if the fused operator would require these parameters as part of its computation. The parameters may include one or more of: data types, tensor shapes, data formats, and any other hyper-parameters that are specific for the individual ops within the sub-graph. Next, the matched pattern in the original graph is replaced with the new fused operator. This process may be repeated for all patterns in the operator fusions file, eventually resulting in a new computation graph (304a, 304b, 304c) containing all supported fused operators. That is, the input computation graph may be analyzed for inclusion of some or all patterns occurring in the operator fusions file.

Another use-case for embodiments or aspects of the invention relates to the design stage of fused operators supported by hardware platforms. Machine learning and neural network technologies evolve at a fast pace, and designing hardware support for fused operators for state of the art ML algorithms requires in-depth knowledge of these algorithms. Embodiments or aspects of the invention, paired with a cost model, may be provided which enable designers to get a quick performance estimate for a potential set of supported fused operators without having to investigate the particular details of the machine learning algorithm.

FIGS. 4A and 4B illustrate, in embodiments or aspects 400, 450 examples of non-prioritized and prioritized operator fusion patterns 401, 451 respectively. FIGS. 4A and 4B illustrate the differences between op-fusions relying on non-prioritized patterns 401 as input to compiler 410 as opposed to prioritized patterns 451. In order to make operator fusion patterns adaptable such that a previous fusion pattern does not hinder fusibility of any new overlapping patterns, prioritized patterns 451 use a prioritized list of patterns such that all patterns are sorted based on some criteria. One criterion for sorting could be a maximum number of fused operators in a fusion pattern. Other sorting criteria could be based on maximum memory optimization and maximum compute utilization.

In more detail, FIG. 4A illustrates a set of Fused Op Patterns X 405, including Fused Op A, which are target-independent fusion patterns. That is, the Fused Op Patterns X can be replaced with a fused operator regardless of the target platform. FIG. 4A further illustrates a set of Fused Op Patterns Y 406, including Fused Op B and Fused Op C, which are specific to a particular target platform. Without any priority assignment, the pattern Fused Op A is fused first. Then the pattern Fused Op B is fused. The resulting computation graph 415 is shown as output of the compiler 410. The compiler and pattern matcher thereof is unable to find and fuse Fused Op C, because the underlying operations op4 and op5 are already fused. This may be sub-optimal because the computation graph could have been more efficiently expressed using only Fused Op B and Fused Op C.

FIG. 4B illustrates an alternative configuration in which the patterns Fused Op A, Fused Op B and Fused Op C are prioritized, in this example based on length of pattern. That is, Fused Op B and Fused Op C, which are longer, are implemented (searched for in the input computation graph and replaced with corresponding fused operators when found) before Fused Op A. As such, the computation graph 455 output by the compiler 410 is different, and more optimal because it includes only Fused Op B and Fused Op C.

Some fusion patterns can be prioritized over others in the sense that, if the computation graph includes two overlapping fusion patterns, the higher-priority patterns are selected for replacement with fused operators in the new computation graph, rather than the lower-priority patterns.

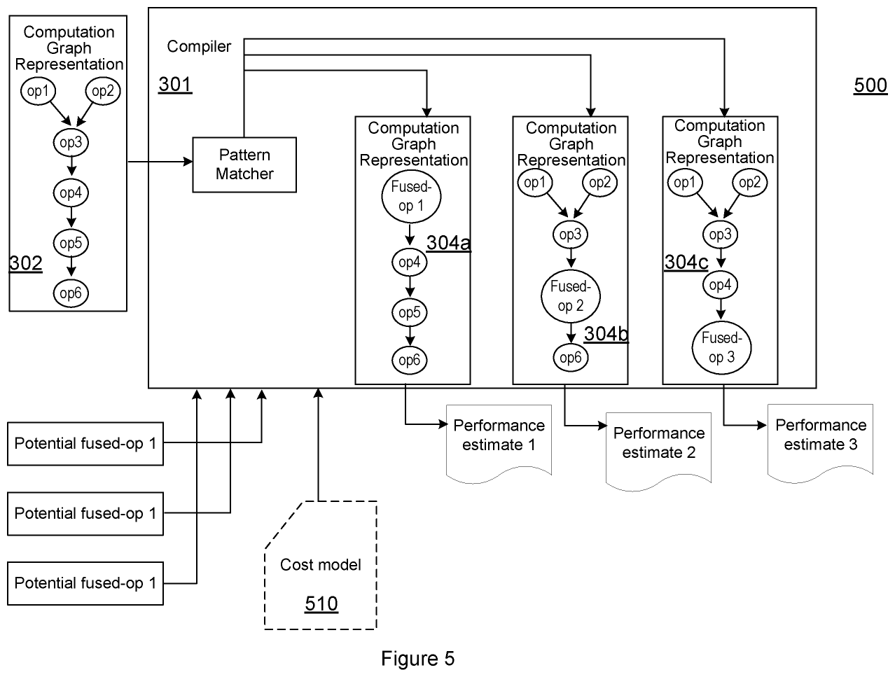

FIG. 5 illustrates an embodiment of a performance estimation model 500 for fused operators. In particular, FIG. 5 shows how a cost model 510 can be used, along with the fused operator solutions described herein, to evaluate the performance improvements resulting from each of a plurality of potential fused operator solutions under consideration. Each fused operator solution can include a list of fusion patterns for use in analyzing an input computation graph. This helps system designers take a decision on what fused operators to support in the target hardware platform at design stage. An embodiment or aspect includes determining, based on the cost model 510 associated with the target hardware execution device, a computation cost associated with generating the fused operators. Analyzing the performance may be based on the computation cost associated with generating of each of the one or more fused operators. The cost is not necessarily a monetary cost, but rather may be a value indicating relative desirability of certain outcomes. Costs can be performance metrics, which indicate the performance of fused operator solutions to which they are applied. Solutions with lower costs are preferred over solutions with higher costs. As used herein, costs can include utilities, which may be viewed as negative costs reflecting desirability according to some predetermined criteria. Costs can reflect performance aspects related to physical design, component usage, computation time, computation complexity, etc.

The above computation cost is a cost incurred by the target hardware platform. This may be a proposed target hardware platform still in the design or development stage. In this case, the impact of fusing a set of ops is still being explored, and the cost model corresponding to the target hardware platform may be used to predict performance gains resulting from a particular set of available fusions. By using the cost model, designers of hardware back-ends may be enabled to explore the impact of different operator fusions (i.e. implementing different fused operators). This provides a mechanism by which the designers can decide which operator fusions should be supported in the developed hardware.

For example, the compiler 301 can receive multiple potential fused operator solutions and the cost model, as well as the input computation graph. The compiler can compute multiple new respective computation graphs based on the different potential fused operator solutions and evaluate these using the cost model. The output of the evaluations can include performance estimates. The performance estimates may provide a quantitative estimate of the performance of a target hardware platform when implementing the computation graph using its available fused operators.

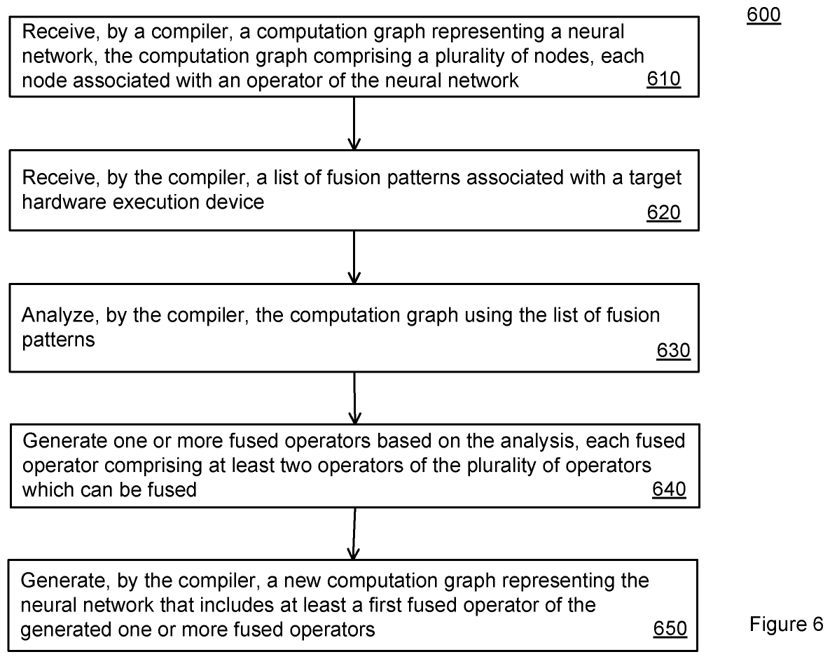

FIG. 6 illustrates, in one example embodiment, a method 600 of generating a neural network computation graph including fused operators. Details of the method 600 will be clear in view of the preceding discussion.

The method includes, at operation 610, receiving, by a compiler 201, a computation graph 302 representing a neural network, the computation graph comprising a plurality of nodes, each node associated with an operator of the neural network;

The method includes, at operation 620, receiving, by the compiler 201, a list of fusion patterns associated with a target hardware execution device;

The method includes, at operation 630, analyzing, by the compiler 201, the computation graph 302 using the list of fusion patterns;

The method includes, at operation 640, generating one or more fused operators based on the analyzing, each fused operator comprising at least two operators of the plurality of operators which can be fused; and

The method includes, at operation 650, generating, by the compiler, a new computation graph 304a, 304b, 304c representing the neural network that includes at least a first fused operator of the generated one or more fused operators.

In one aspect, based on a cost model associated with the target hardware execution device, a computation cost associated with the generating of each of the one or more fused operators can be determined. Fusion patterns can be prioritized based on the cost model. For example, a prioritization among fusion patterns, which results in relatively lower computation cost can be assigned to those fusion patterns.

In another embodiment or aspect, each fusion pattern in the list of fusion patterns may be associated with a condition for generating a fused operator. The condition can relate to requirements that must be satisfied, for example in the target hardware execution device, in order for the fused operator to be viably implemented. In some embodiments or aspects, the condition for generating the fused operator relates to at least one of a memory allocation requirement associated with the fused operator, a size of a feature map input to a layer of the neural network, and a size of a filter of a layer of the neural network. In some embodiments or aspects, the neural network includes a convolution layer and the condition specifies a constraint on at least one of: a shape of inputs of the convolution layer, a size of the inputs of convolution layer, and a data type of the inputs of an operation.

In more detail, regarding the above conditions, when a hardware back-end (platform) supports operator fusion, there may be practical constraints on the resulting fused operators, or the magnitude of the fusion. For example, one constraint may reflect that, if the combined input size (number of bits of all inputs being provided) of a fused operator exceeds the allocated input memory space on the target hardware, the fused operator would have an execution problem. As another example, if the target hardware provides an optimized fused operator for a specific set of input tensor shapes (e.g. input feature map shape is 32×32×128 and input kernel/filter shape is 3×3×128×64), the fused operator may be optimized for this and hence should be used. Otherwise the fused operator may be deemed inefficient. As another example, the target hardware platform may provide fused operators only for specific data types of inputs (e.g. 8 bit integers or 16 bit integers may be supported, but not 32 bit floating point inputs).

In one embodiment or aspect, each of the generated fused operators specifies a dataflow of computations which are equivalent to the dataflow of computations of the plurality of nodes of the computation graph representing the neural network. For example, the dataflow of computations can include the dataflow of computations performed by those nodes which the fused operator represents. The computations can be numerical computations. The dataflow can include a specification of the ordering of computations being performed, and how outputs of some computations are provided as inputs to other computations. The dataflow may refer to the data interdependence between multiple computations. More specifically, the dataflow may refer to the flow of data, from first computations providing output, to other computations which utilize that output as their input. For example, a first computation may be performed, and its output used as input to a second computation. The dataflow may thus reflect the flow of output from the first computation to the second computation. The directed edges of the computation graph, which connect computation nodes, may represent the dataflow, in the sense that the each edge represents the flow of data from one node's output to another node's input.

In various embodiments or aspects, the method further comprises outputting the generated one or more fused operators to the target hardware execution device for execution. This can include, for example, providing instructions to the target hardware execution device which cause the device to implement the new computation graph at least in part using the fused operators that are implementable on the device.

In some embodiments or aspects of the invention, the generated one or more fused operators are output to the target hardware execution device for execution. The output may be a computation graph including the fused operators. As described above, the fused operators may have previously been generated in accordance with the priorities assigned to each fusion pattern in the list of fusion patterns.

It is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device and pursuant to one or more, or a part of one or more, program elements, modules or objects generated from any programming language. In addition, each operation, or a file or object or the like implementing each said operation, may be executed by special purpose hardware or a circuit module designed for that purpose.

Through the descriptions of the preceding embodiments and aspects, the present invention may be implemented by using hardware only or by using software and a necessary universal hardware platform. Based on such understandings, the technical solution of the present invention may be embodied in the form of a software product. The software product may be stored in a non-volatile or non-transitory computer readable storage medium. The software product includes a number of instructions that enable a computer device (personal computer, server, or network device) to execute the methods provided in the embodiments and aspects of the present invention. The software product may additionally or alternatively include number of instructions that enable a computer device to execute operations for configuring or programming a digital logic apparatus in accordance with embodiments and aspects of the present invention.

Although the present invention has been described with reference to specific features and embodiments or aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving, by a compiler, a computation graph representing a neural network, the computation graph comprising a plurality of nodes, each node associated with an operator of the neural network;
receiving, by the compiler, a list of fusion patterns associated with a target hardware execution device;
analyzing, by the compiler, the computation graph using the list of fusion patterns;
generating one or more fused operators based on the analysis, each fused operator comprising at least two operators of the plurality of operators which can be fused; and
generating, by the compiler, a new computation graph representing the neural network that includes at least a first fused operator of the generated one or more fused operators.

2. The method of claim 1, further comprising determining, based on a cost model associated with the target hardware execution device, a computation cost associated with the generating of each of the one or more fused operators, and wherein the analyzing is based on the computation cost associated with the generating of each of the one or more fused operators.

3. The method of claim 1 wherein each fusion pattern in the list of fusion patterns is associated with a condition for generating a fused operator.

4. The method of claim 3, wherein the condition relates to at least one of a memory allocation requirement associated with the fused operator, a size of a feature map input to a layer of the neural network, and a size of a filter of a layer of the neural network.

5. The method of claim 4, wherein the neural network includes a convolution layer and the condition specifies a constraint on at least one of a shape of a kernel of the convolution layer, a size of the kernel of convolution layer, and a data type of an execution kernel associated with the fused operator.

6. The method of claim 1, wherein each of the generated one or more fused operators specify a dataflow of computations which are equivalent to the dataflow of computations of the plurality of nodes of the computation graph representing the neural network.

7. The method of claim 6, further comprising outputting the generated one or more fused operators to the target hardware execution device for execution.

8. The method of claim 7, further comprising assigning priorities to each fusion pattern in the list of fusion patterns based on a cost model.

9. The method of claim 8, wherein the generated one or more fused operators are output to the target hardware execution device for execution in accordance with the priorities assigned to each fusion pattern in the list of fusion patterns.

10. A non-transitory computer readable medium storing instructions executable in one or more processors, the instructions when executed in the one or more processors causing operations comprising:
receiving, by a compiler, a computation graph representing a neural network, the computation graph comprising a plurality of operators of the neural network;
receiving, by the compiler, a list of fusion patterns associated with a target hardware execution device;
analyzing, by the compiler, the computation graph using the list of fusion patterns and generating one or more fused operators based on the analysis, each fused operator comprising at least two operators of the plurality of operators which can be fused; and
generating, by the compiler, a new computation graph representing the neural network that includes at least a first fused operator of the generated one or more fused operators.

11. The non-transitory computer readable medium of claim 10, wherein the instructions are executable to cause operations comprising assigning priorities to each fusion pattern in the list of fusion patterns based on a cost model.

12. The non-transitory computer readable medium of claim 10, further comprising determining, based at least in accordance with the cost model, a computation cost associated with the generating of the one or more fused operators.

13. The non-transitory computer readable medium of claim 12, wherein, in accordance with the cost model, the computation cost is determined based on generating the one or more fused operators at the target hardware execution device.

14. The non-transitory computer readable medium of claim 10, wherein the list of fusion patterns specifies a condition for generating a fused operator based on the plurality of operators.

15. The non-transitory computer readable medium of claim 14, wherein the condition relates to at least one of a memory allocation requirement associated with the fused operator, an input feature relating to supported operator fusion patterns for the target hardware execution device, and a filter size in accordance with a neural network layer of the neural network.

16. The non-transitory computer readable medium of claim 14, wherein the condition specifies a constraint on at least one of a kernel shape, a kernel size and a data type of an underlying execution kernel associated with the fused operator.

17. The non-transitory computer readable medium of claim 10, wherein the generated one or more fused operators specify a flow of computations in accordance with a plurality of nodes of the neural network.

18. The non-transitory computer readable medium of claim 17, the instructions being executable to cause operations comprising providing the generated one or more fused operators to the target hardware execution device associated with a set of hardware platform specific patterns.

19. The non-transitory computer readable medium of claim 17, wherein the generated one or more fused operators are in accordance with a set of priorities assigned to each the set of hardware platform specific patterns as provided to the compiler.

20. An apparatus comprising:
a processor; and
a memory storing instructions that when executed by the processor cause the apparatus to:
receive a computation graph representing a neural network, the computation graph comprising a plurality of nodes, each node associated with an operator of the neural network;
receive a list of fusion patterns associated with a target hardware execution device;
analyze the computation graph using the list of fusion patterns;
generate one or more fused operators based on the analysis, each fused operator comprising at least two operators of the plurality of operators which can be fused; and
generate a new computation graph representing the neural network that includes at least a first fused operator of the generated one or more fused operators.
